(19) United States
(12) Patent Application Publication
(10) Pub. No.: US 2005/0251067 A1
(43) Pub. Date: Nov. 10, 2005

(54) Lower extremity passive muscle manipulation device and method

(75) Inventor: Daniel Terry, Gold River, CA (US)

Correspondence Address: QUINE INTELLECTUAL PROPERTY LAW GROUP, P.C., P O BOX 458, ALAMEDA, CA, 94501, US

(73) Assignee: The Regents of the University of California, Oakland, CA (US)

(21) Appl. No.: 11/111,673

(22) Filed: Apr. 20, 2005

Related U.S. Application Data
(60) Provisional application No. 60/568,414, filed on May 5, 2004.

(51) Int. Cl. A61H 1/00

(52) U.S. Cl. 601/5; 601/23; 601/27; 601/34

(57) ABSTRACT

This invention provides a mechanical lower extremity manipulation device to increase venous blood flow in lower extremities for the prevention of deep vein thrombosis (DVT), pulmonary embolism (PE), lower extremity edema, and other associated or related conditions. Foot plates pivoting on a base plate can be powered to provide a reciprocating action to the feet of a reclining patient. Straps can hold the patient's legs against the base plate so that the reciprocating action results in alternate planar flexion and dorsal flexion of the foot without movement of the leg in general. The resulting elongation and retraction of lower leg muscles can improve venous blood flow to reduce the risk of pathologies, such as DVT.

### CROSS-REFERENCE TO RELATED APPLICATIONS

This application claims priority to and benefit of a prior U.S. Provisional Application No. 60/568,414, LOWER EXTREMITY PASSIVE MUSCLE MANIPULATION DEVICE AND METHOD, by Daniel Terry, M.D., filed May 4, 2004. The full disclosure of the prior application is incorporated herein by reference.

### FIELD OF THE INVENTION

This invention relates to the use of a motorized passive muscle manipulation device. More specifically, this application relates to such a device applied to a user's lower extremity to cause repeated flexion and extension at the ankle to induce increased natural blood flow in a user's lower extremity for the prevention of Deep Vein Thrombosis (DVT) and Pulmonary Embolism (PE) by reducing the pooling or clotting of blood in the soleal veins of the lower extremity.

### BACKGROUND OF THE INVENTION

Venous thromboembolic disease (VTED) and deep vein thrombosis (DVT) continue to be causes of significant morbidity and mortality for individuals immobilized during prolonged travel, after orthopedic surgery, neurological disorders, and a variety of other conditions. Complications from DVT kill an estimated 200,000 people per year, more than AIDS and breast cancer combined. There is an urgent need for solutions to fight this silent, yet formidable, killer.

Studies have shown that at least two of three factors are needed to trigger thrombosis. Reduction of blood flow, especially in the venous sinuses of the calf muscles, has long been recognized as an important risk factor. The venous pooling triggers coagulation and at the same time consumes local anticoagulants. This explains the high risk of DVT and pulmonary embolisms in spinal cord injury, stroke, and post-surgery patient care where immobility of the lower limbs occurs. Additionally, prolonged dependency stasis, a state imposed by airplane flights, automobile trips and even attendance at the theater, can unpredictably bring on venous thrombosis. Until recently, it was not known if only travel, without other risk factors, was sufficient to cause venous thrombosis.

Recent studies indicate that in people over 50 years of age, a history of recent travel is a risk factor by itself for thromboembolic disease. Additionally, travel longer than four hours can increase the risk substantially, even in healthy individuals over 50 years of age. With the decreased legroom in airliners and the escalating time spent in the cramped situation of economy class, a new term has developed, Economy Class Syndrome, for the increasing travel-associated venous thromboembolic disease (VTED). In travel associated VTED, additional risk factors include pressure on the calves from the back of a seat exacerbating venous stasis, dehydration, hemocentration, and a decrease in fibrinolysis.

Current approaches to prophylaxis for DVT include mechanical compression of the calf muscles using pneumatic compression devices, anticoagulation therapy, electrical stimulus, simple nylon compression stockings and vena cava filters. While all these techniques have demonstrated some level of effectiveness, they also have inherent problems. For example, a first method and technology for reducing the probability of DVT, pneumatic compression, includes equipment that is too cumbersome for use by mobile patients and, for use during prolonged travel. One such device is disclosed in U.S. Pat. No. 6,296,617 entitled, “Gradient Sequential Compression System for Preventing Deep Vein Thrombosis” issuing to Peeler et al on Oct. 2, 2001. Generally, these devices are known as intermittent pneumatic compression boots or “IPCB's”. Pneumatic compression equipment is complex, difficult to operate and difficult to maintain. Further, inappropriate application of pneumatic compression equipment can potentially induce deep vein thrombosis, rather than prevent its occurrence. Still further, proper application of pneumatic compression equipment requires personnel with advanced skills. Lastly, a caregiver or user cannot readily determine visually or otherwise whether the pneumatic compression is producing the desired increased blood flow.

A second method and technology for reducing the probability of DVT, anticoagulation therapy using antithrombotic agents, carries the risk of bleeding complications. A caregiver must start a patient's anticoagulant therapy several days in advance to be effective. Additionally, for patient's coming out of surgery, the use of antithrombotic agents could greatly extend the healing period, or, it may not be possible to even use chemical anticoagulation therapy because the risk of excessive bleeding would be too great for the patient. Further, dosage amounts may be based upon trial and error, which further increases the risk for a patient.

A third method and technology for reducing the probability of DVT, electrical stimulation, may be ineffective in properly stimulating the user's calf muscles to produce the desired increased blood flow. Further, the electrical stimulus can be quite irritating to the user, causing the user to discontinue operation of the device. A number of U.S. patents teach methods of applying electrical stimulation for the prevention of DVT. These include the following patents: the Powell, III patent, U.S. Pat. No. 5,358,513; the Tumey patent, U.S. Pat. No. 5,674,262; the Dennis, III patent, U.S. Pat. No. 5,782,893; the Katz patent, U.S. Pat. No. 5,643,331, the more recent Katz patent, U.S. Pat. No. 6,002,965, and the Unsworth patent, U.S. Pat. No. 6,615,080. All but one of these patents describe methods of electrically stimulating the calf muscle to cause enhanced blood flow. Unsworth is slightly different in that electrical stimulation is applied to the sole of the foot to cause plantar flexion, which proximately causes the calf muscle to contract. Tumey is also slightly different in that electrical stimulation of the calf muscle is coupled with pneumatic compression of the foot. However, each of these electrical stimulation methods has drawbacks that the present invention overcomes.

For example, positioning the electrodes on the calf muscle or the sole of the foot can be problematic. The differences in size and shape of people's calf muscles or feet requires fitting cuffs or adjusting sole plate size to ensure accurate placement of the electrodes. Often these electrode presenting cuffs or bands shift or slide down the leg with use. Electrodes applied to the soles of the feet also shift or become dislodged. One irritating problem is the removal of the electrode from the calf when the hair on the leg becomes bound to the sticky electrode. Another difficulty with calf stimulators is that the fatty tissue layer has a relatively high resistance to electric current. This fatty surface layer, between the electrode and the muscle beneath, requires higher current settings for stimulation adequate to contract the muscle. These higher current settings, especially with obese patients, can cause significant discomfort to the skin area around the electrode. Additionally, for calf muscle stimulation, a relatively high current setting is required to cause contraction. Again, higher current pulses are more likely to cause sensations that the user finds unpleasant, especially when administered over a long period.

An additional treatment to prevent DVT and pulmonary embolisms involves the use of a vena cava filter. A vena cava filter is a device inserted into a major vein to prevent a blood clot from traveling to the lungs, creating a pulmonary embolism. Insertion of a vena cava filter is an invasive procedure. The patient is prepared for this procedure using standard surgical protocols and the vena cava filter is commonly implanted in the jugular vein in the neck or the femoral vein in the groin. A vena cava filter is generally indicated when a patient: cannot receive medications that can dissolve a clot (anticoagulation therapy); is known to have a thrombus in a deeply situated vein; experiences a complication from anticoagulation therapy such as bleeding; experiences failure of anticoagulation therapy to prevent a pulmonary embolism; has an embolus in the lungs (pulmonary embolectomy) removed; has a recurrent embolism while receiving adequate medications; or, has significant bleeding complications during anticoagulation therapy. Consequently, a vena cava filter is generally presented as an option when other treatments for DVT fail or are unusable. However, due to the invasive nature of the approach, the use of a vena cava filter can result in the death of a patient.

Another approach to reduction of DVT involves the use of compression stockings. Elastic stockings have been used to treat varicose veins and their complications for over 150 years. In more recent times, graduated pressure has been used to encourage venous blood flow. Graduated pressure refers to the application of varying degrees of pressure, with pressure greatest at the ankle and decreasing proximally. Compression stockings attempt to prevent DVT by affecting the three key factors, venous stasis, vessel injury and coagulation. External compression reduces the cross sectional area of the limb and increases the velocity of blood flow in both superficial and deep veins. This increased velocity of blood reduces venous stasis and decreases the risk of thrombus formation by reducing venous wall distension, local contact time, and the concentration of coagulation reactants. External compression also improves venous valve function, reducing stasis of blood in the cusps. There has been some debate over the appropriate length of compression stockings. Thigh-length compression stockings are more expensive, are more difficult to put on and less well tolerated than the shorter knee length stockings. However, as most studies have used thigh length stockings, further research is needed to determine if knee length stockings achieve the same results. While compression stockings are considered relatively complication free, there are some potential risks with their use. The main risk is a reduction in cutaneous blood flow because of the pressure, which may lead to impaired subcutaneous tissue oxygenation. Patients with peripheral arterial disease and diabetics with neuropathy are at particular risk. Complications include arterial occlusion, thrombosis and gangrene. The complications are linked to extended periods of sitting while wearing compression stockings, and to the tourniquet effect of multiple layers of bunched-up stocking combined with a swelling of the leg. Consequently, although compression stockings might be viewed as a somewhat benign prophylactic for treatment of DVT, improper use can actually worsen a patient's condition and induce DVT.

In addition to devices developed specifically for the prevention of DVT, there also exist a plethora of devices designed for exercising the lower extremities to improve muscle and ligament strength. These systems are generally designed for the purpose of moving and exercising the entire leg, including the foot, calf and thigh. None are directed to manipulation of the foot so as to cause repetitive plantar and dorsal flexion for the prevention of DVT. For example, U.S. Pat. No. 6,152,855 entitled “In-bed Exercise Machine and Method of Use” issued to Dean, Jr. et al on Nov. 28, 2000 describes a system having pedals attached to a linear ram type device for moving a user's entire leg to exercise the muscles of the thigh and calf via flexion at the knee joint. The primary purpose of the Dean, Jr. patent is to prevent muscle atrophy in patients that are bedridden, but awake. The machine is unable to provide ankle flexion without exercising the entire leg.

In U.S. Pat. No. 6,447,428, entitled “Exercise Device,” issued on Sep. 10, 2002, to McKillip, a device that mimics pedaling of a bicycle is described. Again, manipulation of the entire leg is required, which would not be suitable for a patient in post-operative recovery, lying in a supine position.

In U.S. Pat. No. 6,375,598, entitled “Exercise and Physical Performance Monitoring System,” issued on Apr. 23, 2002 to France, et al, an exercise device is disclosed which is based on the motion of linear rams and requires full leg motion.

Devices do exist that alternately flex and extend a user's ankle joints, but these devices can not be employed in therapeutic sessions, e.g., with bed ridden patients. For example, U.S. Pat. No. 6,572,514, “Exerciser with Counter-Reciprocating Pedals”, to Calafato, describes pivoting pedals riding on motorized cams to alternately rise and fall. U.S. patent application Ser. No. 2004/0176219, “Exercise Device for Loser Legs”, by Breneman, describes a device for seated airliner passengers using a motorized crank system to alternately flex and extend a foot strapped to a pedal. In U.S. patent application Ser. No. 2004/0171971, “Powered Antithrombotic Foot Mobility Device with Therapeutic Massage” by Ravikumar, et al., a system of bladders alternately lift foot pedals on a floor base while a series of bladders in a massage sock directs venous blood out of the foot. Each of these devices is positioned on the floor, with the user sitting during use. None of these devices are appropriate for therapy of a bed ridden patient. These devices can not hold the user's leg in place so the exercise motion is focused on the ankle.

In view of the above, a need exists for a device and method of enhancing blood flow in the lower extremity without the problems associated with pneumatic compression, compression stockings, vena cava filters, anticoagulant therapy, electrical stimulation or full leg exercise devices. A need exists for a device for enhancing lower extremity blood flow that can be put on effortlessly, without fitting or adjustments, and, once fitted to a user, does not shift or slip out of place during operation and use. It would be desirable to have a lower extremity blood flow enhancement device that is comfortable and pleasurable to use. Benefits could also be realized from a lower extremity blood flow enhancement device that can be reliably used by obese patients. Yet still further, a lower extremity blood flow enhancement device is needed that can be quickly and easily applied to an immobile patient after surgery without increasing complications of recovery. A device is desirable that can obtain effective calf muscle contraction and elongation to enhance blood flow in the user's lower extremity to prevent DVT without necessarily exercising a user's entire leg. Of particular benefit would be a convenient efficient device that can flex and extend the ankles of a patient lying in a bed. The present invention provides these and other features that will be apparent upon review of the following.

### SUMMARY OF THE INVENTION

In accordance with the present invention, a lower extremity passive muscle manipulation and joint articulation, for prevention of DVT and other related conditions, comprises, e.g., a motor attached to a base which drives rigid arms linked to pivotally-hinged footplates. Continuous pivoting motion of the footplates cause repeated excursion of a user's foot between alternating plantar and dorsal flexion, thereby causing alternating contraction and elongation of the calf muscle to increase blood flow in the deep veins of the calf.

The present invention includes devices for flexing and extending the ankles of reclined patients. The devices for improving venous blood flow can include one or more foot plates mounted to a base plate at a pivot point (e.g., hinge mount), a horizontal extension of the base plate that extends at least 4 inches, 24 inches, or more, beyond the pivot point on the foot side of the foot plate, and a working means in functional contact with the one or more foot plates to power reciprocating motion in the foot plate. The base plate is typically a planar structure. The reciprocating motion of the foot plates imparts a reciprocating motion to a foot in functional contact with the foot side of the one or more foot plates, thereby improving venous blood flow. The entire device can be positioned on a reclined surface with the under side of the base plate disposed in contact with the reclined surface.

The working means can be any source of power coupled to a mechanism in functional contact with the foot plates to provide a reciprocating motion. The power source can be muscle power (e.g., from the user) or power from a motor, such as an electric motor, air motor, internal combustion motor or other mechanical actuator. In one embodiment, the working means is a solenoid in functional contact with a foot plate. The power source can make functional contact with the working side (or less preferably, other parts of the foot plate) of the foot plate through a cam mechanism or a crank and rod mechanism. A vertical portion of the base plate can be provided to mount the power source and to back up the working means against the forces involved in reciprocating the plates and feet. For example, the vertical portion can extend vertically from the horizontal base plate and a motor can be mounted to the vertical portion in the functional contact with the working side of the foot plate. Alternately, the motor can be mounted to the horizontal base plate. A sheet guard can be mounted, e.g., on a vertical portion of the base plate to hold bedding away from contact with moving device components.

The device can operate with the base plate horizontal extension disposed in contact with a reclined surface. The horizontal extension can be mounted to the reclined surface using an attachment means, such as a strap, a belt, and a hook and loop connector. Optionally, the reclined surface can comprise the horizontal extension. The horizontal extension of the base plate can include one or more retaining devices to substantially immobilize the user's leg, e.g., in the region of the ankle, lower leg or thigh. Padding can be positioned on the horizontal extension at locations supporting the ankle, knee or thigh of a device user to stabilize the leg and enhance comfort.

The foot plates can be pivotably mounted (e.g., with a hinge) at a pivot point of the base plate. The foot plates can have a foot strap or an inflatable cuff to hold the user's foot in contact with the foot side of the plate. In a typical embodiment, two foot plates are provided which move in opposite directions during the reciprocating motion. Optionally, two feet can share a common, e.g., wide foot plate.

The device can be placed or mounted onto a reclined surface so that the user's lower extremities are elevated during use, e.g., compared to a regular up right sitting position. The user's leg can be positioned in the device with the heel near the pivot point, with the sole of the foot in contact with the foot plate and the leg substantially straight (extended) at least partly resting on the horizontal extension of the base plate. The user can be sitting or lying down on her back. The leg can be horizontal, somewhat lowered, or somewhat elevated. The reclined surface can be, e.g., the upper surface of a bed, table (such as a surgical table), floor, recliner chair, or other seat that has a surface to lift and straightens the legs. The device can be stabilized on the reclined surface by its own weight and the weight of the user's leg, or the device can be further fixed to the reclined surface with one or more attachment means, such as a strap, a belt, and a hook and loop connector.

Methods of the invention can be practiced, e.g., using the devices of the invention. The methods can include, e.g., reclining a person on a reclined surface, placing a foot of the person in functional contact with a foot plate pivotably mounted to a base plate disposed upon the reclined surface, retaining the person's leg in contact with the base plate (typically the horizontal extension section), and reciprocating the foot plate with power from a working means. During practice of the method, the person's leg and knee joint typically remain essentially immobile while the foot alternately experiences plantar flexion and dorsal flexion. This method can improve circulation of blood and lymph, and/or improve the range of motion in the person's ankle.

In the method, the reclined surface is typically a bed. The person's leg can be retained in position, e.g., by holding the ankle, lower leg and/or thigh to the base plate with a strap, a belt, and a hook and loop connector. The person's feet can be strapped onto the foot plates to reciprocate in unison or in opposite directions. Damage to bedding and irritation to the person can be avoided by holding bedding away from contact with the foot plate or working means, e.g., using a guard shield.

The working means can be any mechanism that supplies power and functional contact to reciprocate the pivotable foot plates. For example, the working means can have electric motor power or power from lower leg muscles of the person experiencing the method.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or biological systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content clearly dictates otherwise. Thus, for example, reference to “motor” can include a combination of two or more motors; reference to “a strap” can include one or more straps, and the like.

The term “reclined surface”, as used herein, refers to a substantially horizontal surface, or surface that is more horizontal than vertical, on which a persons leg is supported in association with methods or devices of the invention. For example, the reclined surface can be horizontal or at an angle of less than 5 degrees, 10 degrees, 15 degrees, 20 degrees, or less than 30 degrees from horizontal. The reclined surface can be, e.g., a bed, a floor, a seat, or the like. A “reclined person” is a person sitting or lying with his or her knee joint substantially extended and with his or her lower extremities extended along the reclined surface. The one or more of the person's lower extremities can be supported by a base plate horizontal extension with optional additional support from the reclined surface (as shown, e.g., in the Figures).

The term “working means”, as used herein, refers to a means of providing power and functionally directing the power to impart a reciprocating motion to the foot plates. Power can come from any power source, such as a motor, an electric motor, air pump, air motor, hydraulic system, solenoids, piezoelectric device, electroactive polymers, etc. Power from the poser source can be applied to impart the reciprocating motion, e.g., through a crank and rod system, bellows systems, solenoids, pneumatic actuators, rods, cylinders, pistons, cams, and/or the like, in contact with one or more foot plate.

The term “horizontal extension”, as used herein, refers to a section of the base plate that extends from the pivot point (where foot plates pivot) some distance to the superior end of the base plate (i.e., from the pivot point in the direction of the device user's lower extremities; e.g., to the right of the pivot point, as shown in the figures). The horizontal extension is typically planar on the underside to conform well with the reclined surface on which it is commonly disposed.

Unless defined otherwise, all technical and scientific terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

### BRIEF DESCRIPTION OF THE DRAWINGS

FIG. 1 is a side view that illustrates the device applied to a patient in a bed, according to the present invention.

FIG. 2 is a side view that illustrates the placement of a user's foot in dorsal flexion, causing the calf muscle to elongate, according to the present invention.

FIG. 3 is a side view that illustrates the placement of a user's foot in plantar flexion, causing contraction of the calf muscle, according to the present invention.

FIG. 4 is a top view illustrating the simultaneous plantar and dorsal flexion of both the user's feet, according to the present invention.

FIG. 5 is a top view that illustrates a preferred embodiment of the invention where the driving motor is located on the patient side of a support structure, according to the present invention.

FIG. 6 is a side view that illustrates a preferred embodiment of the invention where the driving motor is located on the patient side of a support structure, according to the present invention.

### DETAILED DESCRIPTION

Methods and devices of the invention can, e.g., hold the leg of a reclining patient in place while the patient's foot is alternately flexed and extended. This movement of the foot can alternately contract and elongate muscles of the lower leg to improve circulation of blood in the region. The improved blood flow can help prevent or treat maladies, such as deep vein thrombosis, lower extremity edema, pulmonary embolism, and the like.

### Devices for Lower Extremity Muscle Manipulation

Devices for manipulation of the ankle joint can improve circulation of blood and lymph in the lower extremities. The devices can also be used in physical therapy to help retain range of motion in ankle joints of bed ridden patients. The devices can be designed to provide reciprocating motion to the feet of a patient in a partially or fully reclined position, with the legs generally extended at the knee. The devices can include, e.g., two foot plates mounted at a pivot point on a base plate that rests, e.g., on the patient's bed. The patient's feet can be positioned with the plantar surfaces of the feet in contact with a foot side of the foot plates, and the patient's leg resting over a portion (horizontal extension) of the base plate. A motor can power reciprocating motions in the foot plates that imparts the desired movement in the foot, ankle and lower leg muscles. The patient's leg (particularly the knee joint) can be immobilized by strapping it to the horizontal extension of the base plate.

The Base Plate

The base plate of the muscle manipulation device can provide a framework for mounting of other system components and provide a base for functional contact with the reclined surface and the patient's leg. The base plate can include, e.g., a hinged mounting for foot plates, a mounting location for motors and mechanisms that transmit motion to the foot plates, attachment means to fix the device to a patient's bed, retention means to hold the patients legs still while the feet are reciprocated, and a mounting location for device accessories, such as user controls and sheet guards.

The base plate can be, e.g., a planar sheet of substantially rigid material that can be laid over a mattress, or other reclined surface, to provide a stable platform for the work of the device. The base plate can be, e.g., wide enough to provide backing to one or two legs. The base plate can be long enough to provide a mounting surface, e.g., for motors and reciprocating components in contact with the work side of the foot plates in addition to the horizontal extension length. For example, the base plate can be as narrow as a leg or as wide as a bed; from less than about 6 inches wide to more than about 4 feet wide, from about 1 foot to about 3 feet wide, or about 2 feet wide. This can provide lateral stability to the device. The base plate can be less than 1 foot long to more than 6 feet long, from about 2 feet long to about 4 feet long, or about 3 feet long. This can provide longitudinal stability to the device relative to the patient and reclined surface.

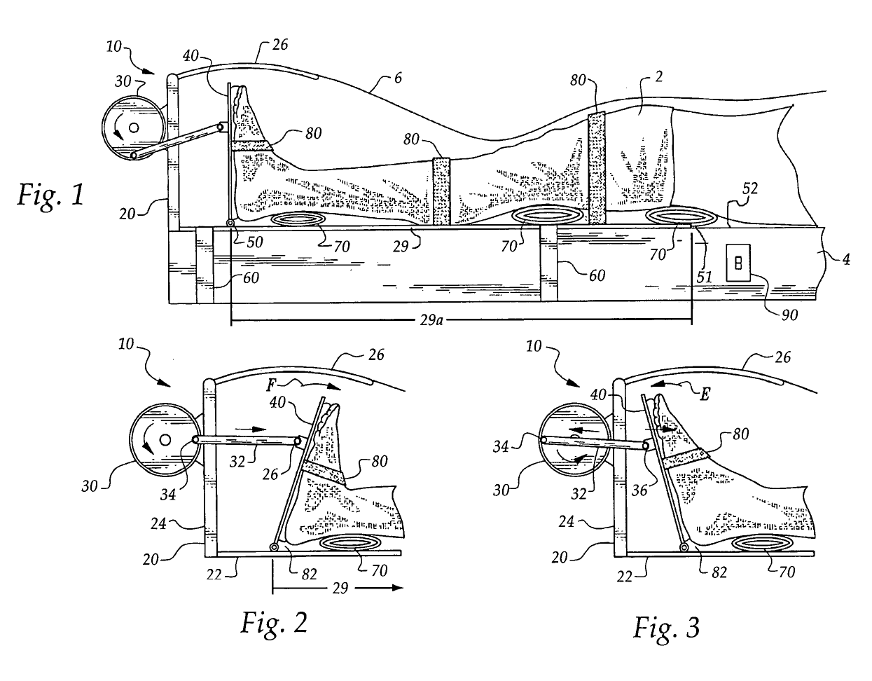

The base plate can have a pivot point 50 for mounting of the foot plates 40 (see FIGS. 1 to 3). The pivot point can be the location on the base plate where a foot plate pivots during operation of the device, e.g., where a foot plate hinge is mounted. Such a hinge can be, e.g., cylinder and hinge pin type, a flexing resilient material type, etc. The pivot point can be oriented or adjustable to make the foot plates pivot in a desired comfortable and functional arch.

The base plate can extend beyond the pivot point to provide a horizontal extension disposed upon the reclined surface 52 for some distance, e.g., to stabilize the device during operation and/or to provide a base of attachment for retention devices used to immobilize the patient's leg. This base plate horizontal extension 29 can run from 4 inches or less, to 5 feet or more in length from the pivot point to the superior end 51 of the base plate, for an extension length 29a. Optionally, the base plate horizontal extension can have a length of about 6 inches to about 4 feet, from about 1 foot to about 3 feet, or about 2 feet. The horizontal extension can have one or more retainer devices to hold the patient's leg onto the base plate. The horizontal extension can have one or more attachment devices to help hold the device onto the reclined surface.

A section of the base plate distal (to the left in the Figures) from the pivot point can afford a location to mount mechanisms associated with movement of the foot plates. For example a length of base plate on the working side of the pivot point can have a vertical portion 24 of the base for mounting of a motor 30 to power reciprocating motions, or a reciprocating crank mechanism intended for patient powered reciprocation. The distal portion of the base plate can support a mounting means for a guard 26 that keeps objects out of the reciprocation mechanisms.

Foot Plates

Foot plates can be pivotably mounted to the base plate at pivot points. The foot plates can have a working side 41 for functional contact with the reciprocation mechanisms and a foot side 42 for contact with the sole (plantar surface) of the patient's foot. The foot side of the foot plates can have padded or resilient material to increase the comfort to the user. The working side can have connecting points to receive reciprocating forces from the working means. The foot plates can be made of a substantially ridged material with one end adapted to articulate with the base plate at the pivot point.

Foot plates can be, e.g., as long and wide as a user's foot, or more. For example, the plates can be from less than 3 inches long and 2 inches wide to more than about 12 inches long and 6 inches wide. In embodiments where two feet share a single foot plate, the plate can be double wide with some consideration for spacing of the feet.

The foot plates can have a component to help hold the foot in functional contact with the foot plate. This is typically accomplished by mounting an elastic or adjustable strap 80 to the foot plates so that the foot remains in contact with the foot side of the foot plate when the plate reciprocates in the distally.

Reciprocation Working Means

The working means of the device provides power and reciprocating motion required in operation of the device. For example, a crank mechanism can convert powered rotary motion of a motor to a reciprocating motion imparted to the foot plates by contact with crank rods.

Power for the working means can be provided from any reasonably convenient source. Typically, a motor, such as an electrical motor is used to power the reciprocating motion of the foot plates. Although the motor can be run using batteries, the motor us usually powered by commonly available alternating current from a utility. Such motors generally output mechanical energy as a rotating force at a gear or pulley. Although one skilled in the art can envision a variety of ways to convert the powered rotational motion into reciprocating motion (e.g., cams, escapements, hydraulic pumping mechanisms, etc.), the preferred mechanism is a crank and rod. For example, a crank 31 connecter to a rod 32 at a first end, can transfer kinetic energy to a foot plate in contact with a second end of the rod.

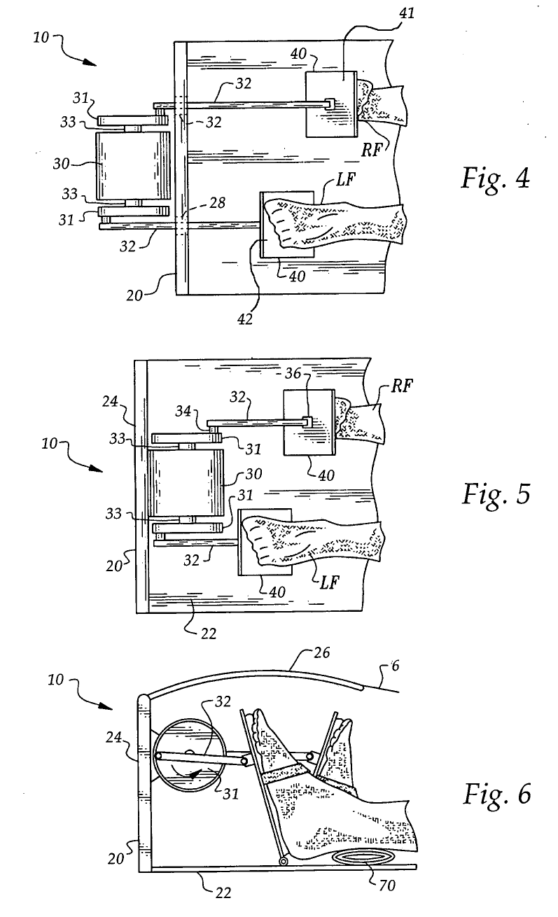

In one embodiment, the patient herself can provide power required in the working means. For example, the foot plates can be connected to a crank mechanism, as shown in FIGS. 4 and 5, but, e.g., with the motor replaced with a flywheel 30 (optionally, the armature of the motor can act as a fly wheel). Downward pressure of the patient's right foot, as shown in FIG. 4, can power the dorsal flexion of the left foot. The subsequent pushing by left foot can power the dorsal flexion of the right foot back to the starting position.

In many embodiments, a vertical portion rises up from the base plate on the working (distal) side of the pivot point to provide a foundation on which the working means be mounted to push against the working side of the foot plates. Optionally, the working means can be mounted to the distal horizontal section of the base plate.

In some embodiments the peak pressures applied by the working means on the foot plates can be adjustable or has a peak pressure cut off. For example, the springs or hydraulic dampeners can be incorporated into the rods of a crank mechanism so that peak forces to the foot plates are reduced. The springs can have adjustable tension, as is known in the art, so that the peak transmitted forces are adjustable.

In still other embodiments, the range of the foot plate pivoting motions can be adjustable. Such adjustments can take into consideration the available range of motion existing in the ankle joint of each particular patient. Such an adjustment can be accomplished by techniques known in the art, such as having the point of contact between a crank rod and working side of the foot plate be slidable to various positions closer or further from the pivot point; or by having a variable crank arm length.

### Methods of Lower Extremity Muscle Manipulation

Methods of lower extremity muscle manipulation can be useful in improving the range of motion in an ankle joint or improving circulation of blood in a lower extremity. The methods of the invention generally include reclining a patient with his or her legs along a reclined surface. The foot of the patient is placed with the heel positioned at the base of the foot plate near the pivot point of a device of the invention. The leg can be extended along the horizontal extension of the base plate and supported by the reclined surface and/or horizontal extension. A working means, such as a crank mechanism powered by an electric motor, reciprocates the foot plate along with the patient's foot to provide the desired benefits.

In one embodiment of the methods, a patient is positioned on a reclined surface for therapy in a device that includes a foot plate pivoting on a base plate and powered for a reciprocating motion. The patient's foot is placed on the pivoting foot plate and the patient's leg is immobilized by strapping it onto a horizontal base plate extension disposed on the reclined surface. The reciprocating motion of the pivoting foot plate is imparted to the patient's foot so that it alternately experiences dorsal flexion and plantar flexion. The patient can benefit, e.g., from improved blood circulation and/or range of ankle joint motion.

In another embodiment, the patient is positioned on a reclined surface for therapy in a device that includes two foot plates each pivoting on a base plate. The patient's feet are placed on the pivoting foot plates and the patient's legs are immobilized by strapping them onto a horizontal base plate extension disposed on the reclined surface. The patient alternately pushes with the left foot then the right foot to generate a reciprocating motion of the pivoting foot plates through a crank and flywheel mechanism. The lower leg exercise and alternate dorsal flexion and plantar flexion of the ankle joint can provide therapeutic benefits.

In the methods, the patient can be reclining on a reclined surface. The patient can be, e.g., flat on his back in a bed. Optionally, the patient can be sitting in a seat having a reclined surface support to the leg that does not allow substantial flexion of the knee. The reclined surface can be substantially horizontal, or inclined at an angle 30 degrees, 15 degrees, 5 degrees, or less, from horizontal.

The patient is positioned with his feet in contact with the foot plates and with his legs extended over a horizontal extension of a base plate. The feet can be held in contact with the foot plates, e.g., using a strap or other retaining mechanism. His legs can be held in contact with the horizontal extension using a retaining device, such as, e.g., a strap, belt, elastic band, VELCRO™ hook and loop fastener, and/or the like. Depending on the length of the base plate horizontal extension, the patient's legs can contact the extension in at least the region of the ankle, the calf, the knee, and/or the thigh.

The speed, force and stroke of the reciprocating foot plate motion can be optionally varied to suit the needs of the patient. For example, the speed can be varied by controlling a variable resistor, which controls the power circuit to an electric powered working means. The stroke (range of motion) and force of the reciprocating foot plates can be controlled, e.g., mechanically, as described above.

Pads can optionally be located between the leg and horizontal extension to further ensure the stability of the leg and to enhance comfort during therapy. Pads can be inserted, e.g., behind the ankle, behind the knee, and/or under the thigh, to support and protect the leg. It can be desirable to provide a pad at the superior end of the horizontal extension so the extension edge does not irritate the patient.

### EXAMPLES

Several objects and advantages of the present invention in the following examples can include:
(a) Providing a reliable mechanical device and method for preventing DVT by mechanically stimulating the calf muscles by alternate plantar and dorsal flexion of each foot, thereby naturally inducing increased blood flow in the soleal venal plexus, without the risks and irritations common to the prior art.
(b) Mimicking the natural action of the calf muscle during use.
(c) Avoiding misdirected vein compression which might actually induce thrombosis, as with pneumatic compression techniques.
(d) Simplifying the administration and operation of the device.
(e) Eliminating the use of sticky electrodes necessary for electrical stimulas.
(f) Working regardless of the obesity and thickness of fat tissue of a user.
(g) Preventing uncomfortable hair entanglement.
(h) Simple and flexible application to even a comatose patient.
(i) Avoidance of complex treatments with unknown side effects.
(j) Avoidance of complex treatments that might worsen a patient's potential for DVT.
(k) Requiring only one size for virtually all users.
(l) Allowing visual verification of operation.
(m) Providing flexibility in the manner and method of treatment, including frequency, duration, degree of ankle flexion and level of contraction and elongation of the calf muscle.

A first example device of the present invention is shown in FIG. 1. Generally, a base plate 20 is removably attached to a user's bed 4. The base 20 is secured to the user's bed with straps 60. The base 20 supports a motor 30 that reciprocatingly drives a footplate 40, causing a user's foot to alternate between plantar and dorsal flexion at the ankle. Footplate 40 is pivotally attached to the base 20 by a hinge 50. Pads 70 support the user's leg at key points. Leg straps 80 secure the user's leg to the base 20 and footplate 40. A control switch 90 is used to operate the motor 30.

In greater detail and referring to FIG. 1, in the device 10 according to the present invention, a user's leg and foot are shrouded within a stockingette 2. The user's leg is comfortably secured to a base 20 over the horizontal extension 29 region having a length 29a. The base 20 includes a horizontal portion 22, a vertical portion 24, and an upper sheet guard 26. One skilled in the art will recognize that the base 20 may be made from several different materials and in several different manners. The base 20 is constructed with sufficient structural strength to carry the weight of a motor 30 and to absorb forces associated with driving footplates 40 secured to the user's feet. The horizontal portion 22 of the base 20 should be of sufficient length and weight to create a lever arm that counteracts forces applied to the vertical portion 24 when the device 10 is in operation. As shown in FIG. 1, generally the horizontal extension 29 of the base 20 can extend approximately to an area adjacent the user's upper leg. The horizontal portion 22 of the base 20 is then secured to the bed 4 by straps 60. The straps are preferably made from nylon or other similar material with means for tightening the straps 60 to hold the base 20 securely in place on the bed mattress 4 without excessive motion. Other means of attachment may be used in place of the straps 60 so long as the base 20 is securely held in place on the bed mattress 4. The upper sheet guard 26 extends sufficiently beyond the footplate 40 to prevent any bedding sheets 6 from laying on any area of the user's foot or lower leg while in operation. The guard 26 may be extended further to create more open space around the footplate 40 and the user's foot to avoid irritation by rubbing of the sheet 6 against a user's leg.

Now, in further detail, the elements of the present invention are described. Referring to FIG. 1, in this first embodiment, the motor 30 is attached to an outboard side of the vertical portion 24 of the base 20. Referring to FIG. 4, the motor 30 includes drive shafts 33 that rotatably drive two crank disks 31. Two crank arms 32 (rods) are pivotally attached to their respective crank disks 31 at first ends 34 and to their respective footplates 40 at second ends 36. Crank arms 32 pass through the vertical support 24 of the base 20 at penetrations 28. Penetrations 28 are of sufficient size to allow crank arms 32 to freely travel in the penetrations 28 during use and operation of the device 10 by a patient.

A user's foot is securely cinched to a footplate 40. The footplate 40 is attached to a pivotal hinge 50, attached to the base 20 at the pivot point. Straps 60 secure the device 10 by its base 20 to the bed 4. Soft padding 70, in the form of a rolled towel, is placed under key support points along the user's leg, including just behind the user's heel, under the user's thigh, just above the back of the knee, and under the upper portion of the user's thigh. Proper placement of the padding 70 maintains proper position of the user's leg with respect the footplate 40. Alternate forms of padding may be used in place of rolled toweling including cylindrical tubes of foam rubber. Further, a unitary foam rubber pad may be used which extends from near a user's heel adjacent the foot plate hinge 50 to include the user's entire thigh. An appropriate foam rubber for use as a unified pad could be of the type produced by TEMPURPEDIC™. Optionally, an inflatable cushion could be used to provide support and cushioning under the user's leg as an alternative to a foam rubber cushion. An inflatable cushion could be periodically adjusted with addition or subtraction of air pressure to provide a secure, but comfortable operation of the device 10.

Soft cotton straps 80 secure the user's feet and leg to the device 10 at the footplates 40 and the horizontal extension 29 of the base 20. A cotton pad 82 is provided between the sole of a user's foot and the footplate 40 to provide a more comfortable surface to the user.

A control switch 90 is provided for operation by the user to deliver power to the motor 30. The operation of the motor 30, including rotational speed, may be varied by the use of a conventional motor control system (not shown).

While FIG. 1 through 3 illustrate application of the device 10 to only one foot, it is to be understood that for most applications each of a user's feet will be secured to a footplate 40 of the device 10 since DVT might occur in either of the user's legs. Application to both feet simultaneously is illustrated in FIG. 4 through 6.

FIGS. 5 and 6 illustrate a preferred embodiment of the invention 10 where the driving motor 30 has been located on the patient side of the vertical support structure 24, where it is less likely to be brushed by someone walking by and less likely to become entangled with sheets 6 draped over the foot of the bed. In this preferred embodiment, the motor 30 is attached to the patient side of the vertical support structure 24. A sheet guard 26 extends over the motor 30, the crank arms 32, the footplates 40 and the user's feet. Consequently, the sheet 6 covering the patient is prevented from becoming entangled in the working mechanism of the passive manipulation device 10, and, the user's feet are kept clear of the sheet 6 and do not constantly rub against the sheet 6, which would be annoying and uncomfortable for a user.

In operation of the device 10, FIG. 2 and FIG. 3 illustrate the operation of the device 10 on a user's foot between full plantar and dorsal flexion at the user's ankle. FIG. 4 illustrates the positioning of the device 10 when applied to both feet simultaneously. More specifically, FIG. 2 illustrates the position of the crank arm 32 and the footplate 40 when operating and placing the user's foot at full dorsal flexion. As shown in FIG. 4, the motor 30 includes a drive shaft 33 that drives a crank disc 31 in a rotational manner. A crank arm assembly 32, connected to the crank disc 31 by a pivotally attached crank pin 34, converts the rotational motion of the disc 31 to linear motion in the crank arm 32. A footplate 40 pivotally attached by a footplate pivot pin 36 to the crank arm 32 and pivotally attached to the horizontal portion 22 of the base 20 by a hinge 50 converts the linear motion of the crank arm assembly 32 to an arcing motion at the footplate 40. Referring once again to FIG. 2, when the user's foot is at maximum dorsal flexion, where the top of the forefoot is driven superiorly (toward the user's body) in the direction indicated by the arrow F, the crank connection pivot point 34 is closest to the vertical support 24. The crank arm 32 connected at its footplate connection pivot point 36 to the footplate 40 pushes the footplate 40 to its furthest distance away from the vertical support 24. In this position, the user's foot is driven in a dorsal flexion direction F, causing the user's calf muscle to elongate.

Referring now to FIG. 3, the position of the crank arm 32 and footplate 40 is shown when the user's foot is driven in an extending direction E, placing the user's foot in a plantar flexion state, causing the user's calf muscle to contract.

The continual rotation of the crank disc 31 causes the footplate 40 to continually reciprocate in an arcing motion. This arcing motion causes the user's foot to continually move from a position of dorsal to plantar flexion, alternating the elongation and contraction of the user's calf muscle and producing a natural muscular venal pumping action. The pumping action increases the blood flow in the venal soleous of the user's calf muscle, thereby reducing the potential for DVT.

While the invention has been described above in connection with the particular embodiments and examples, one skilled in the art will appreciate that the invention is not necessarily so limited. It will thus be understood that numerous other embodiments, examples, uses, modifications of, and departures from the teachings disclosed may be made, without departing from the scope of the present invention as claimed herein. In all preferred embodiments of the system and devices that are described herein and that effect the method which, together with those devices forms the subject matter of this invention, it is to be understood that these preferred embodiments of the invention are only meant to be examples of the principal features of the invention. Each of the illustrations contain features of preferred embodiments, but it is to be understood that some of these features could be incorporated into the other preferred embodiments and features deleted from those preferred embodiments or both. It is understood that the examples and embodiments described herein are for illustrative purposes only and that various modifications or changes in light thereof will be suggested to persons skilled in the art and are to be included within the spirit and purview of this application and scope of the appended claims.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

1. A device for manipulating lower leg muscles, the device comprising:
one or more foot plates mounted to a base plate at a pivot point, which one or more foot plates comprise a foot side and a working side;
a horizontal extension of the base plate that extends beyond the pivot point on the foot side of the foot plate; and,
a working means in functional contact with the one or more foot plates to power a reciprocating motion of the one or more foot plates;
whereby reciprocating motion of the one or more foot plates imparts a reciprocating motion to one or more feet of a person in functional contact with the foot side of the one or more foot plates, thereby manipulating lower leg muscles of the person.

2. The device of claim 1, wherein the horizontal extension extends at least 4 inches from the pivot point to superior end of the base plate.

3. The device of claim 1, wherein the horizontal extension extends at least 24 inches from the pivot point to superior end of the base plate.

4. The device of claim 1, wherein the working means comprises: an electric motor or user power.

5. The device of claim 4, wherein the motor makes functional contact with the working side of the foot plate through a cam mechanism or a crank and rod mechanism.

6. The device of claim 4, further comprising a vertical portion of the base plate extending vertically from the horizontal base plate, and wherein the motor is mounted to the vertical portion in the functional contact with the working side of the foot plate.

7. The device of claim 1, further comprising a reclined surface, and wherein the horizontal extension is disposed upon the reclined surface.

8. The device of claim 7, further comprising an attachment means selected from the group consisting of: a strap, a belt, and a hook and loop connector; whereby the horizontal extension is held in contact with the reclined surface.

9. The device of claim 1, wherein the one or more foot plates further comprise a foot strap.

10. The device of claim 1, wherein the reciprocating motion is provided to two foot plates in opposite directions.

11. The device of claim 1, further comprising one or more retaining device mounted to the base horizontal extension, whereby a leg of a user can be held onto the horizontal extension in the region of the ankle, lower leg or thigh.

12. The device of claim 1, further comprising padding positioned on the horizontal extension at locations supporting the ankle, knee or thigh of the person.

13. The device of claim 1, further comprising a sheet guard mounted on the base plate to hold bedding away from contact with moving device components.

14. A device for manipulating lower leg muscles, the device comprising:
a reclined surface;
a base plate disposed upon the reclined surface;
one or more foot plates mounted to the base plate at a pivot point; and,
a working means in functional contact with the one or more foot plates to power a foot plate reciprocating motion;
whereby reciprocating motion of the one or more foot plates imparts a reciprocating motion to a person's foot in functional contact with the one or more foot plates, thereby manipulating the person's lower leg muscles.

15. The device of claim 14, wherein the reclined surface comprises: a bed, table or leg support of a seat.

16. The device of claim 14, wherein the base plate comprises a horizontal extension that extends superiorly at least 4 inches beyond the pivot point.

17. The device of claim 14, wherein the working means comprises an electric motor or power from the person.

18. The device of claim 17, wherein the motor makes functional contact with the the foot plate through a cam mechanism or a crank and rod mechanism.

19. The device of claim 17, further comprising a vertical portion extending from the base plate, and wherein the motor is mounted to the vertical portion and in the functional contact with the foot plate.

20. The device of claim 14, wherein the base plate is mounted to the reclined surface with an attachment means.

21. The device of claim 20, wherein the attachment means is selected from the group consisting of: a strap, a belt, and a hook and loop connector.

22. The device of claim 14, wherein the one or more foot plates further comprise a foot strap.

23. The device of claim 14, wherein the reciprocating motion is provided to two foot plates in opposite directions.

24. The device of claim 14, further comprising retaining devices mounted to the base plate, whereby an ankle region, lower leg or thigh leg of a user can be held in contact with the base plate.

25. The device of claim 14, further comprising padding on the base plate at locations supporting an ankle, knee or thigh of a device user.

26. The device of claim 14, further comprising a sheet guard mounted on the base plate to hold bedding away from contact with moving device components.

27. A method of manipulating lower extremity muscles, the method comprising:
reclining a person's lower extremity along a reclined surface;
placing a foot of the person in functional contact with a foot plate pivotably mounted to a base plate, which base plate is disposed upon the reclined surface;
retaining the lower extremity in contact with the base plate;
reciprocating the foot plate with power from a working means;
whereby the foot alternately experiences plantar flexion and dorsal flexion, thereby manipulating muscles in the lower extremity.

28. The method of claim 27, wherein the reclined surface comprises: a bed, table or leg support of a seat.

29. The method of claim 27, wherein said retaining comprises holding the ankle, lower leg or thigh of the person to the base plate with a strap, a belt or a hook and loop connector.

30. The method of claim 27, wherein the working means comprises electric motor power or lower extremity muscles.

31. The method of claim 27, wherein the working means comprises electric motor power or the lower extremity muscles.

32. The method of claim 27, further comprising: reciprocating two foot plates in unison or in opposite directions.

33. The method of claim 27, further comprising holding bedding away from contact with the foot plate or working means.
